(19) United States
(12) Patent Application Publication
(10) Pub. No.: US 2005/0273316 A1
(43) Pub. Date: Dec. 8, 2005

(54) Apparatus and method for translating Japanese into Chinese and computer program product

(76) Inventor: Tatsuya Izuha, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/138,463

(22) Filed: May 27, 2005

(30) Foreign Application Priority Data
May 28, 2004 (JP) 2004-159499

(51) Int. Cl. G06F 17/27

(52) U.S. Cl. 704/9

(57) ABSTRACT

A Japanese-to-Chinese machine translation apparatus includes an unregistered word determining unit that determines whether a Japanese word of a Japanese sentence is an unregistered word not registered in a Japanese-to-Chinese translation dictionary. The Japanese-to-Chinese translation dictionary contains Japanese words into which the Japanese sentence is divided, associated with Chinese words. The apparatus also includes an unregistered-word translation generating unit that, when the unregistered word determining unit determines that the Japanese word is the unregistered word, divides the unregistered word into a hiragana string and a non-hiragana string, generates a translation of the non-hiragana string, and does not generate a translation of the hiragana string.

### CROSS-REFERENCE TO RELATED APPLICATIONS

This application is based upon and claims the benefit of priority from the priority Japanese Patent Application No. 2004-159499, filed on May 28, 2004; the entire contents of which are incorporated herein by reference.

### BACKGROUND OF THE INVENTION

1. Field of the Invention

This invention relates to a Japanese-to-Chinese machine translation apparatus and a Japanese-to-Chinese machine translation method for translating a natural Japanese sentence into a Chinese sentence, and a computer program product which causes a computer to execute the method.

2. Description of the Related Art

A Japanese-to-Chinese machine translation apparatus, which accepts natural Japanese sentences to output Chinese translation, generally uses a Japanese-to-Chinese translation dictionary where Chinese language is associated with Japanese language word-by-word or morpheme-by-morpheme.

Such a Japanese-to-Chinese translation dictionary has a maximum capacity for translation words since Chinese language consists of a great number of Chinese characters (kanji) and the dictionary has a maximum data size. Using the Japanese-to-Chinese translation dictionary with a limited number of translation words, Chinese machine translation from Japanese sentences encounters some unregistered words in the accepted Japanese sentences. No Chinese word corresponding to the unregistered word is registered in the Japanese-to-Chinese translation dictionary. Handling and outputting the unregistered word well is a major challenge for Japanese-to-Chinese machine translation.

For example, Japanese Patent Application Laid-Open No. H04-256171 discloses a Japanese-to-Chinese machine translation apparatus that handles such unregistered words. This Japanese-to-Chinese machine translation apparatus uses Japanese-to-Chinese matching data where Japanese kanji is associated with Chinese kanji, to automatically generate a translation, when an unregistered word is a kanji, especially a proper noun, such as the name of a person and the name of a place. This translation apparatus also outputs hiragana characters contained in the unregistered word without translation (i.e., as their copy).

However, Chinese sentences contain no hiragana. Consequently, the output of Chinese translation with hiragana makes conspicuous failure of translation failure and a negative impression on the user. In other words, the user recognizes the Chinese translation with hiragana as an impossible translation or a mistranslation, and thereby may understand the quality of the machine translation is poor.

### SUMMARY OF THE INVENTION

According to one aspect of the present invention, a Japanese-to-Chinese machine translation apparatus includes a storage unit that stores a Japanese-to-Chinese translation dictionary file where Japanese words are associated with Chinese words; an unregistered word determining unit that determines whether a Japanese word of the Japanese sentence is an unregistered word not registered in the Japanese-to-Chinese translation dictionary file; and an unregistered-word translation generating unit that, when the unregistered word determining unit determines that the Japanese word is the unregistered word, divides the unregistered word into a hiragana string and a non-hiragana string, generates a translation of the non-hiragana string with reference to the Japanese-to-Chinese translation dictionary file, and does not generate a translation of the hiragana string.

According to another aspect of the present invention, a Japanese-to-Chinese machine translation apparatus includes a storage unit that stores a Japanese-to-Chinese translation dictionary file where Japanese words are associated with Chinese words; an unregistered word determining unit that determines whether a Japanese word of the Japanese sentence is an unregistered word not registered in the Japanese-to-Chinese translation dictionary file; and an unregistered-word translation generating unit that, when the unregistered word determining unit determines that the Japanese word is the unregistered word, divides the unregistered word into a hiragana string and a non-hiragana string, and does not generate a translation of the hiragana string whose number of characters or syllables is not more than a predetermined value.

According to still another aspect of the present invention, a Japanese-to-Chinese machine translation apparatus includes a storage unit that stores a Japanese-to-Chinese translation dictionary file where Japanese words are associated with Chinese words as being translations of the Japanese words; an unregistered word determining unit that determines whether a Japanese word contained in a Japanese sentence is an unregistered word not registered in the Japanese-to-Chinese translation dictionary file; and an unregistered-word translation generating unit that, when the unregistered word determining unit determines that the Japanese word is the unregistered word, divides the unregistered word into a hiragana string and a non-hiragana string, and does not generate a translation of the hiragana string which is a dependent-word connectable to other Japanese word.

According to still another aspect of the present invention, a Japanese-to-Chinese machine translation method includes determining whether a Japanese word contained in a Japanese sentence is an unregistered word not registered in a Japanese-to-Chinese translation dictionary file where Japanese words are associated with Chinese words; and when the Japanese word is the unregistered word, dividing the unregistered word into a hiragana string and a non-hiragana string, and generating a translation of the non-hiragana string with reference to the Japanese-to-Chinese translation dictionary file, without generating a translation of the hiragana string.

According to still another aspect of the present invention, a Japanese-to-Chinese machine translation method includes determining whether a Japanese word contained in a Japanese sentence is an unregistered word not registered in a Japanese-to-Chinese translation dictionary file where Japanese words are associated with Chinese words; and when the Japanese word is the unregistered word, dividing the unregistered word into a hiragana string and a non-hiragana string, and generating no translation of the hiragana string whose number of characters or syllables is not more than a predetermined value.

According to still another aspect of the present invention, a Japanese-to-Chinese machine translation method includes determining whether a Japanese word contained in a Japanese sentence is an unregistered word not registered in a Japanese-to-Chinese translation dictionary file where Japanese words are associated with Chinese words; and when the Japanese word is the unregistered word, dividing the unregistered word into a hiragana string and a non-hiragana string, and generating no translation of the hiragana string which is a dependent-word connectable to other Japanese word.

According to still another aspect of the present invention, a computer program product according to still another aspect of the present invention causes a computer to perform the method according to the present invention.

### BRIEF DESCRIPTION OF THE DRAWINGS

FIG. 1 is a functional block diagram of a Japanese-to-Chinese machine translation apparatus according to a first embodiment of the present invention;

FIG. 2 shows a Japanese-to-Chinese translation file;

FIG. 3 shows a Japanese-to-Chinese kanji database;

FIG. 4 is a flowchart of whole process of Japanese-to-Chinese machine translation;

FIG. 5A shows a Japanese sentence, and FIG. 5B shows a morphological analysis table before processing an unregistered word;

FIG. 6 is a flowchart of a process of generating a translation of an unregistered word by an unregistered-word translation generating unit;

FIG. 7A shows an unregistered word string array, and FIG. 7B is another example of the unregistered word string array;

FIG. 8 shows the contents of a translation buffer at the time the process of generating the translation of the unregistered word is completed;

FIG. 9 shows the morphological analysis table at the time the process of generating the translation of the unregistered word is completed;

FIG. 10A shows an output of the Japanese-to-Chinese machine translation apparatus according to the first embodiment, and FIG. 10B shows an output of a conventional Japanese-to-Chinese machine translation apparatus;

FIG. 11 is a flowchart of a process of generating a translation of an unregistered word by an unregistered-word translation generating unit of a Japanese-to-Chinese machine translation apparatus according to a second embodiment;

FIG. 12A shows a Japanese language containing a dependent-word, and FIG. 12B is another example Japanese language containing a dependent-word;

FIG. 13 is a functional block diagram of a Japanese-to-Chinese machine translation apparatus according to a third embodiment;

FIG. 14 is a functional block diagram of an unregistered-word translation generating unit;

FIG. 15 shows a data structure of a dependent-word dictionary file;

FIG. 16 shows a data structure of a dependent-word connection table;

FIG. 17 shows an unregistered word containing a dependent-word string;

FIG. 18 is a flowchart of a process of generating a translation of an unregistered word by the unregistered-word translation generating unit of the Japanese-to-Chinese machine translation apparatus according to the third embodiment;

FIG. 19 is a flowchart of a process of extracting a dependent-word by dependent-word extractor;

FIG. 20 shows a data structure of a dependent-word table;

FIG. 21 shows a data structure of a dependent-word index table;

FIG. 22 shows a partial string extracted in the process of extracting the dependent-word; and

FIG. 23 is a flowchart of a process by a determining function FUNC performing dependent-word string analysis determination.

### DETAILED DESCRIPTION OF THE PREFERRED EMBODIMENTS

Exemplary embodiments of a Japanese-to-Chinese machine translation apparatus and a Japanese-to-Chinese machine translation method relating to the present invention will be explained in detail below with reference to the accompanying drawings.

A Japanese-to-Chinese machine translation apparatus according to a first embodiment divides an accepted Japanese sentence into Japanese words to display each of the Japanese words together with a Chinese translation. In particular, the Japanese-to-Chinese machine translation apparatus does not output any hiragana character contained in a Japanese word not registered in a Japanese-to-Chinese translation file.

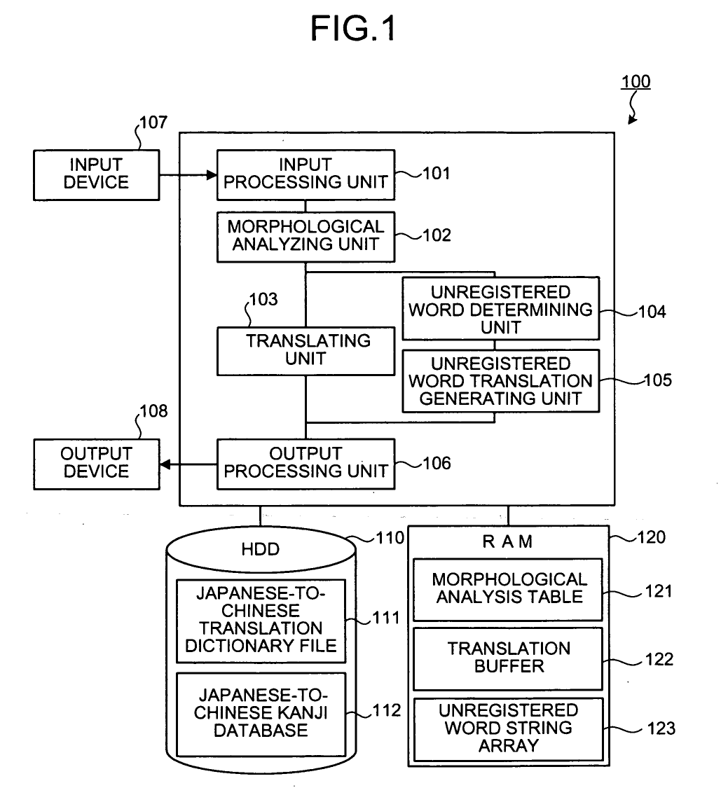

FIG. 1 is a functional block diagram of a Japanese-to-Chinese machine translation apparatus according to a first embodiment of the present invention. The Japanese-to-Chinese machine translation apparatus 100 according to the first embodiment includes an input processing unit 101, a morphological analyzing unit 102, a translating unit 103, an unregistered word determining unit 104, an unregistered-word translation generating unit 105, an output processing unit 106, an input device 107, an output device 108, a hard disk drive (HDD) 110, and a random access memory (RAM) 120.

The input processing unit 101 accepts Japanese sentences via the input device 107 such as a keyboard. The morphological analyzing unit 102 divides the Japanese sentence accepted by the input processing unit 101 into Japanese words each of which is a morpheme while performing a well-known morphological analysis with reference to a Japanese-to-Chinese translation file 111, and registers the divided Japanese words in a morphological analysis table 121.

The Japanese sentence may be divided into words using other analysis and process different from the morphological analysis.

The unregistered word determining unit 104 determines whether a Japanese word registered in the morphological analysis table 121 is an unregistered word. Specifically, whether a Chinese word corresponding to the Japanese word is not registered in the Japanese-to-Chinese translation file 111 is determined.

When the unregistered word determining unit 104 determines that the Japanese word registered in the morphological analysis table 121 is a unregistered word, the unregistered-word translation generating unit 105 generates a translation of the unregistered word. Concretely, the unregistered-word translation generating unit 105 further divides a Japanese word as being an unregistered word into characters or strings for each character type (kanji, hiragana, katakana, alphanumeric character, and the like). Each Japanese kanji out of the characters is assigned to a corresponding Chinese kanji with reference to the Japanese-to-Chinese kanji database 112 but the hiragana string out of the strings is specified to no translation. The translations of other characters, such as katakana and alphanumeric character are expressed in their original transcription.

The translating unit 103 determines, when a Japanese word registered in the morphological analysis table 121 is a registered word, a Chinese word corresponding to the Japanese word the Japanese word to be its translation.

The output processing unit 106 outputs the translation generated by the translating unit 103 and the unregistered-word translation generating unit 105 to the output device 108, such as a display and a printer.

The HDD 110 stores the Japanese-to-Chinese translation file 111 and the Japanese-to-Chinese kanji database 112 therein.

The Japanese-to-Chinese translation file 111 is a dictionary file where each Japanese word is associated with a Japanese transcription, a part of speech, and a corresponding Chinese translation.

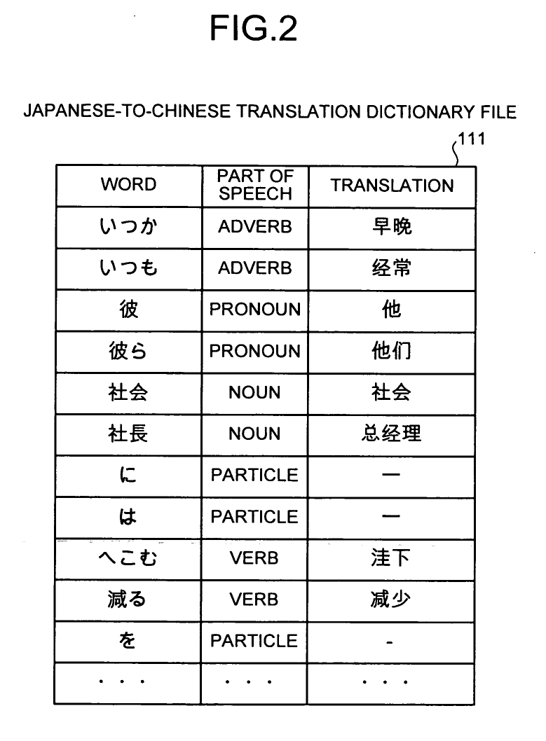

FIG. 2 shows an example of the Japanese-to-Chinese translation file 111. The Japanese-to-Chinese translation file 111 contains a Japanese transcription, a part of speech, and a corresponding Chinese translation which are associated with each word as shown in FIG. 2. The translation of a Japanese word associated with a specific translation symbol “-” is not displayed on the output device 108.

The Japanese-to-Chinese kanji database 112 is a data base where the Chinese kanji such as the simplified Chinese and the traditional Chinese each corresponding to Japanese kanji is registered, and is referred by the unregistered-word translation generating unit 105 when a translation of an unregistered word is generated.

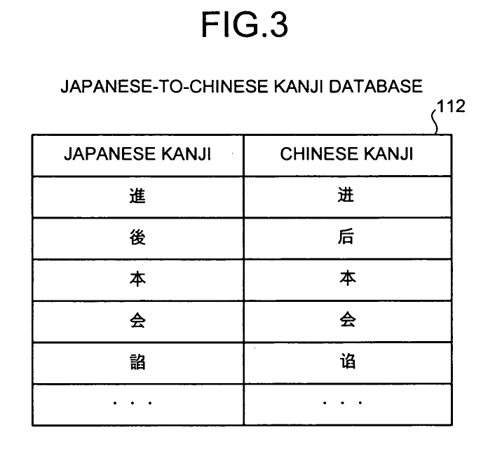

FIG. 3 shows n example of the Japanese-to-Chinese kanji database 112. The Japanese kanji and the Chinese kanji, such as the simplified Chinese and the traditional Chinese each corresponding to the Japanese kanji are registered in the Japanese-to-Chinese kanji database 112 as shown in FIG. 3.

The morphological analyzing unit 102 generates the morphological analysis table 121 in the RAM 120. The unregistered-word translation generating unit 105 generates a translation buffer 122 and an unregistered word string array 123 in the RAM 120. The morphological analysis table 121, the translation buffer 122, and the unregistered word string array 123 may be generated in the HDD 110 instead of the RAM 120.

The morphological analysis table 121 is generated by the morphological analyzing unit 102, and is a data file containing a Japanese transcription, a part of speech, and a corresponding translation word-by-word.

The translation buffer 122 and the unregistered word string array 123 are generated by the unregistered-word translation generating unit 105, and is a buffer which stores characters, such as kanji or hiragana temporarily when a translation of an unregistered word is generated.

A whole process of Japanese-to-Chinese machine translation by the Japanese-to-Chinese machine translation apparatus according to this embodiment will now be explained below.

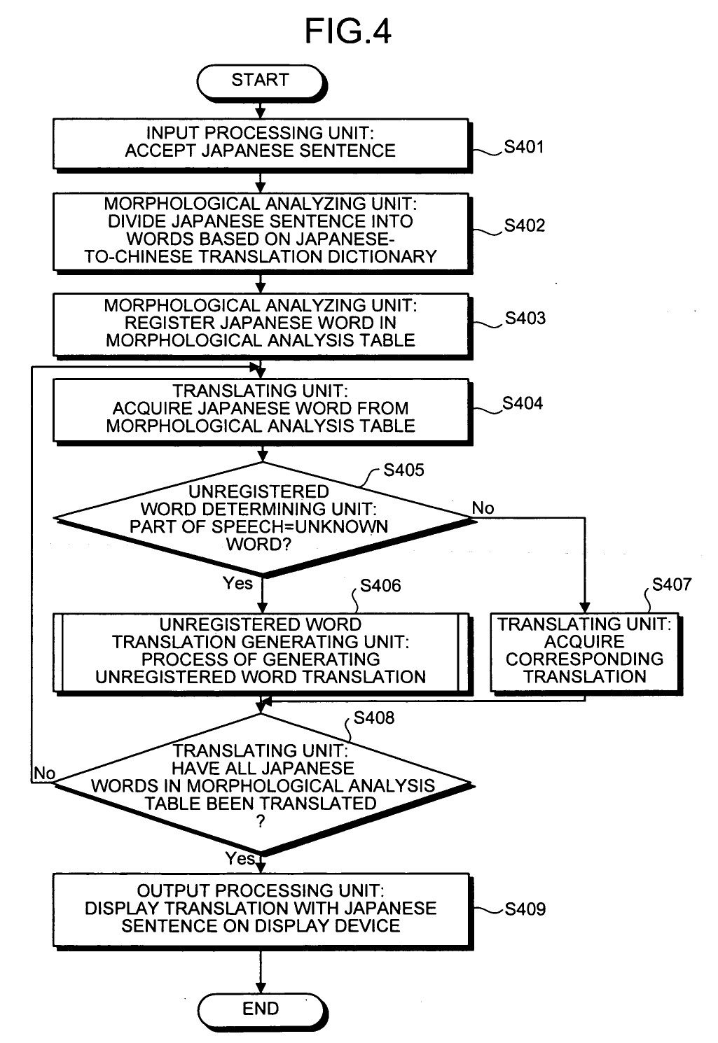

FIG. 4 is a flowchart of whole process of Japanese-to-Chinese machine translation.

When the input device 107 receives a Japanese sentence, the input processing unit 101 accepts the Japanese sentence (step S401). The morphological analyzing unit 102 divides the accepted Japanese sentence into Japanese words, with reference to the Japanese-to-Chinese translation file 111 (step S402). At the same time, the morphological analyzing unit 102 acquires a part of speech and a translation for each Japanese word from the Japanese-to-Chinese translation file 111. Dividing a Japanese word into Japanese words may use other technologies different from the morphological analysis.

The morphological analyzing unit 102 generates the morphological analysis table 121 in the RAM 120, and registers the Japanese words for each Japanese transcription together with the part of speech and the translation which are both acquired, in the morphological analysis table 121 (step S403). If the Japanese word is the unregistered word, which is not registered in the Japanese-to-Chinese translation file 111, the part of speech is registered as “unknown” and the translation is registered as blank data in the morphological analysis table 121.

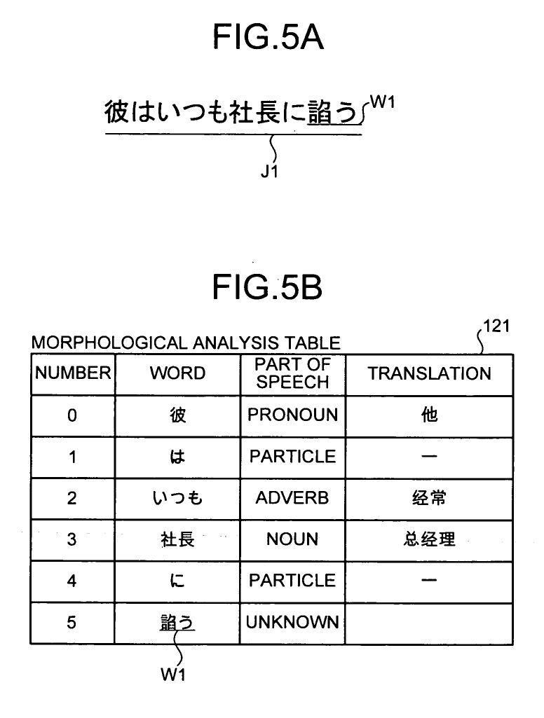

A Japanese sentence J1 shown in FIG. 5A will be taken as an example of acceptance by the input processing unit 101 for understanding of the morphological analysis table 121.

FIG. 5B shows an example of the morphological analysis table 121 at the time the processing of step S403 are completed after the Japanese sentence J1 is accepted. Japanese word number and word, and part of speech and translation which are acquired from the Japanese-to-Chinese translation file 111 are registered in the morphological analysis table 121. If the Japanese word is the unregistered word, which is not registered in the Japanese-to-Chinese translation file 111, like a word W1 as shown in FIG. 5A, its part of speech is registered as “unknown” and its translation is registered as blank data.

The translating unit 103 acquires a Japanese word from the morphological analysis table 121 (step S404). The acquisition of the Japanese word is started from the head of the morphological analysis table 121. The unregistered word determining unit 104 determines whether the part of speech of the Japanese word acquired from the morphological analysis table 121 in step S404 is “unknown” (step S405). In other words, whether the acquired Japanese word is registered in the Japanese-to-Chinese translation file 111 is determined. If the part of speech of the Japanese word does not indicate the unknown word (step S405: No), then the Japanese word is determined that it is not the unregistered word and the translating unit 103 acquires a translation corresponding to the Japanese word from the morphological analysis table 121 (step S407).

If the part of speech of the Japanese word indicates the unknown word (step S405: Yes), then the Japanese word is determined that it is the unregistered word, and the unregistered-word translation generating unit 105 performs a process of generating an unregistered-word translation (step S406). The process of generating an unregistered-word translation in step S406 will be described in detail later.

After step S406, the process from steps S404 to S407 is repeated until all the Japanese words registered in the morphological analysis table 121 has been processed (step S408). As a result, the translation of all the Japanese words is generated, and the output processing unit 106 outputs the Japanese sentence together with the translation to the output device 108 (step S409).

The process of generating the unregistered-word translation performed by the unregistered-word translation generating unit 105 in step S406 will now be explained below.

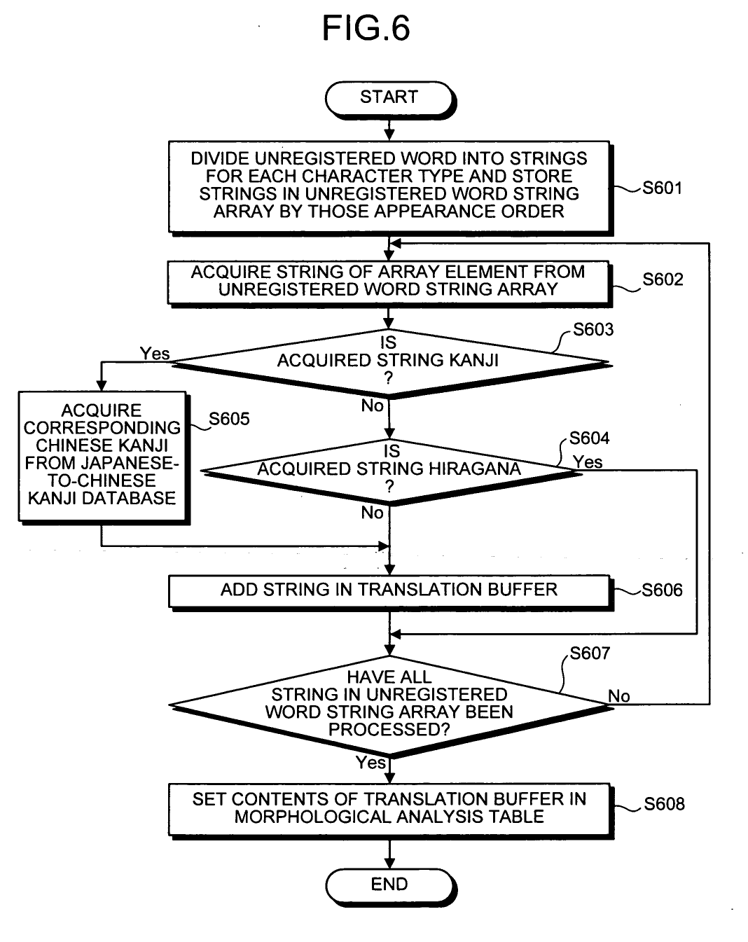

FIG. 6 is a flowchart of a process of generating a translation of an unregistered word by the unregistered-word translation generating unit 105.

The unregistered-word translation generating unit 105 divides a Japanese word not registered in the Japanese-to-Chinese translation file 111 into strings for each character type of kanji, hiragana, katakana, and alphanumeric character, and then stores the strings in separate array elements of the unregistered word string array 123 of the RAM 120 by those appearance order (step S601).

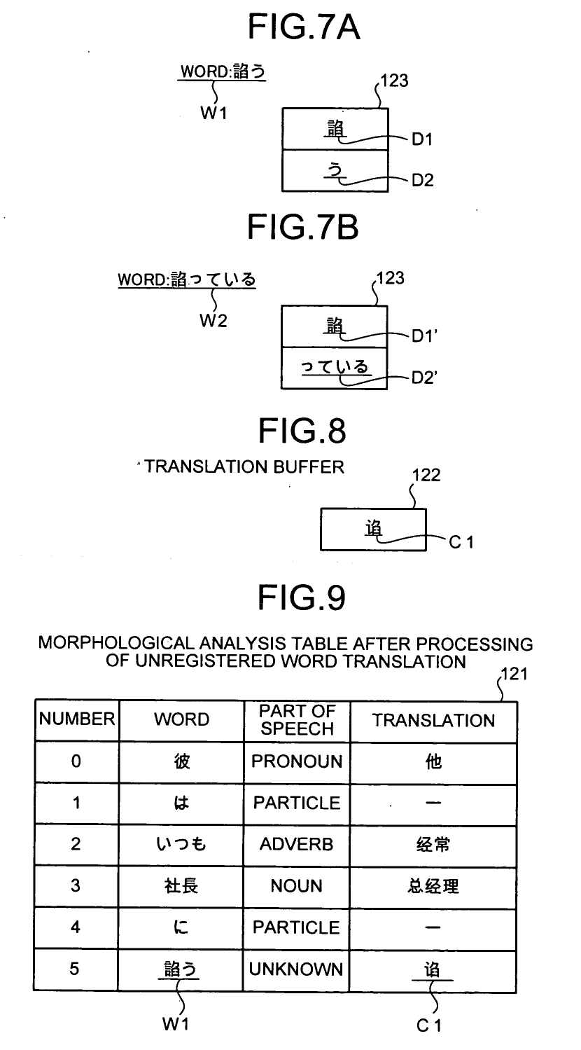

FIGS. 7A and 7B show examples of the unregistered word string array 123. Since a word W1 of the Japanese sentence J1 shown in FIG. 5A is the unregistered word in the Japanese-to-Chinese translation file 111, a kanji D1 and a hiragana D2 each are stored in a separate array element of the unregistered word string array 123 as shown in FIG. 7A. As shown in FIG. 7B, if the unregistered word is a word W2, a kanji D1′ and hiragana D2′ each are stored in a separate array element of the unregistered word string array 123.

After the unregistered word is stored for each string depending on the character type in the unregistered word string array 123 in step S601, the string stored in each array element is acquired from the unregistered word string array 123 to determine whether the acquired string is Japanese kanji (step S603). When the acquired string is Japanese kanji (step S603: Yes), the Chinese kanji corresponding to the Japanese kanji is acquired from the Japanese-to-Chinese kanji database 112 (step S605) and is added to the translation buffer 122 of the RAM 120 (step S606).

When the string acquired from the array element of the unregistered word string array 123 in step S603 is not the Chinese kanji (step S603: No), whether the string is hiragana is determined (step S604). When the string is not hiragana (step S604: No), the acquired string (hereinafter also referred to as “non-hiragana string”) other than hiragana is added to the translation buffer 122 (step S606).

When the string is hiragana (step S604: Yes), the string, i.e. hiragana is not added to the translation buffer 122. In other words, the hiragana of the unregistered word is handled as no translation.

The process from steps S602 to S606 is repeatedly performed on the strings stored in all the array elements of the unregistered word string array 123 (step S607), and then the contents of the translation buffer 122 is set to the morphological analysis table 121 (step S608). The morphological analysis table 121 is supplied to the output processing unit 106 as the translation of the Japanese sentence, and thus only the kanji of the unregistered word is handled as the translation of the unregistered word but the hiragana is output as no translation.

FIG. 8 shows an example of the contents of the translation buffer 122 at the time the process of generating the unregistered-word translation is completed after the Japanese sentence J1 shown in FIG. 5A is accepted. As shown in FIG. 8, only Chinese kanji C1 corresponding to the Japanese kanji D1 among the unregistered word W1 of the Japanese sentence is added to the translation buffer 122 but the hiragana D2 is not added to the translation buffer 122.

FIG. 9 shows an example of the contents of the morphological analysis table 121 at the time the process of generating the unregistered-word translation is completed after the Japanese sentence J1 shown in FIG. 5A is accepted. The contents of the translation buffer 122 shown in FIG. 8, i.e., only the Chinese kanji C1 corresponding to the Japanese kanji D1, is set as the translation of the unregistered word W1 but the hiragana character D2 is not set. Therefore, even when the accepted Japanese sentence contains the unregistered word to be registered in the Japanese-to-Chinese translation file 111, the Chinese translation to be output to the output device 108 contains no hiragana.

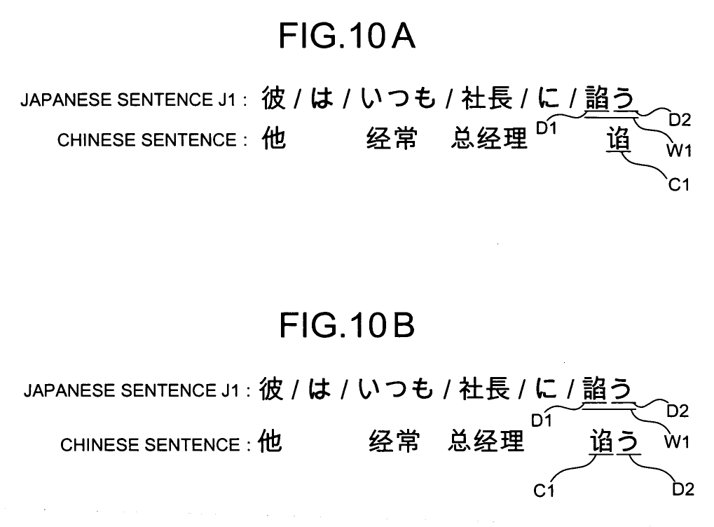

FIG. 10A shows an example of an output of the output device 108 after the Japanese sentence J1 is accepted in the Japanese-to-Chinese machine translation apparatus 100 according to this embodiment. FIG. 10B shows an example of an output of an output device after the Japanese sentence J1 is accepted in a conventional Japanese-to-Chinese machine translation apparatus.

The output of the conventional Japanese-to-Chinese machine translation apparatus as shown in FIG. 10B, the Chinese translation of the unregistered word W1, contains the hiragana D2, which is not transcription of the Chinese language, as well as the Chinese kanji corresponding to the Japanese kanji D1. However, the output of the Japanese-to-Chinese machine translation apparatus according to this embodiment shown in FIG. 10A does not contain such hiragana in the Chinese translation.

The Japanese-to-Chinese machine translation apparatus 100 according to the first embodiment divides an accepted Japanese sentence into Japanese words as being morphemes to display each of the Japanese words together with a Chinese translation. In particular, the Japanese-to-Chinese machine translation apparatus 100 does not output any hiragana contained in a Japanese word not registered in the Japanese-to-Chinese translation file 111. As a result, it is possible to make a good impression at the quality of the machine translation.

The Japanese-to-Chinese machine translation apparatus 100 according to the first embodiment does not output any hiragana contained in a Japanese word not registered in the Japanese-to-Chinese translation file 111. However, hiragana is sometimes used to express a proper noun.

A Japanese-to-Chinese machine translation apparatus 100 according to a second embodiment, only when the number of characters or the number of syllables of hiragana strings of the unregistered word is not more than a predetermined integer n, identifies such hiragana string as, for example, a declensional kana ending, and does not output it as the translation.

The Japanese-to-Chinese machine translation apparatus 100 according to the second embodiment has the same functional structure as that of the first embodiment, and therefore, the explanation thereof will be omitted. According to this embodiment, when the number of characters or the number of syllables of the hiragana string of the unregistered word is not more than a predetermined integer n, the unregistered-word translation generating unit 105 does not add the hiragana string to the translation buffer 122. Besides, when the number of characters or the number of syllables of the hiragana string is larger than the integer n, the unregistered-word translation generating unit 105 adds the hiragana string to the translation buffer 122. The second embodiment is different from the first embodiment in this regard.

The whole process of Japanese-to-Chinese machine translation by the Japanese-to-Chinese machine translation apparatus 100 according to the second embodiment is the same as that of the first embodiment.

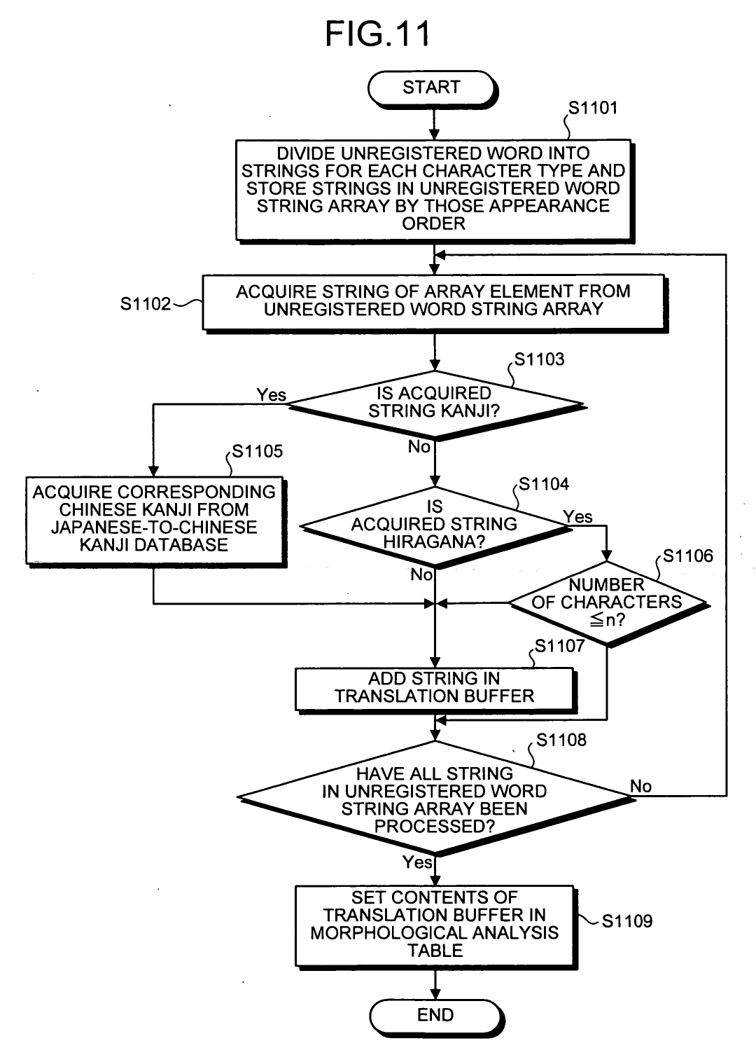

FIG. 11 is a flowchart of a process of generating a translation of an unregistered word by the unregistered-word translation generating unit 105 of the Japanese-to-Chinese machine translation apparatus 100 according to the second embodiment. The integer n represents the number of characters in this embodiment but may represent the number of syllables.

The process from steps S1101 to S1104, in which an unregistered word is divided into strings for each character type, the strings are stored in the unregistered word string array 123, and whether the stored string is hiragana is determined, is the same as the process from steps S601 to S604 in the first embodiment.

When the acquired string is not hiragana (step S1104: No), the non-hiragana string is added to the translation buffer 122 (step S1107).

When the acquired string is hiragana (step S1104: Yes), whether the number of characters of the string, i.e. hiragana string, is not more than the integer n is determined. The integer n can be defined as, for example, a statistical maximum length of declensional kana endings of the unregistered words, but may be various values. The value of n is, for example, two or three. The value of n may be set by the user.

When the number of characters of the hiragana string is not less than n (step S1106: Yes), the hiragana string is not added to the translation buffer 122. When the number of characters of the hiragana string is larger than n (step S1106: No), the hiragana string is added to the translation buffer 122 (step S1107). As a result, the hiragana string whose number of characters is not more than n is determined to be a declensional kana ending of a verb and is output as no translation. Besides, the hiragana string whose number of characters is larger than n is determined to be a proper noun and is output as a translation.

After adding the string to the translation buffer 122, the process from steps S1102 to S1107 is repeatedly performed on the strings stored in all the array elements of the unregistered word string array 123 (step S1108), and then the contents of the translation buffer 122 is set to the morphological analysis table 121 (step S1109). The morphological analysis table 121 is supplied to the output processing unit 106 as the translation of the Japanese sentence, and thus the kanji and the hiragana string whose number of characters is larger than n, of the unregistered word, are handled as the translation of the unregistered word but the hiragana string whose number of characters is not more than n is output as no translation.

As described above, the Japanese-to-Chinese machine translation apparatus 100 according to the second embodiment does not output the hiragana string whose number of characters or syllables is not more than the predetermined integer n as a translation. Besides, all the hiragana strings are always not output, and the hiragana string which has a longer length such as a proper noun is output as the original transcription. As a result, it is possible to make a good impression at the quality of the machine translation.

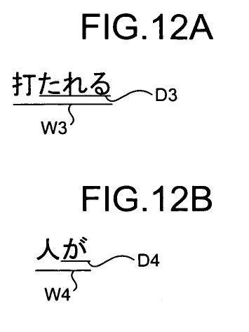

However, even when the number of characters or the numbers of syllables of the hiragana string is larger than the integer n, the hiragana string as has a series of dependent-words may be not a proper noun. The dependent-word is referred as a word not identified as the single phrase, and is, for example, a word D3 in an auxiliary verb W3 as shown in FIG. 12A, or a particle D4 in a Japanese language W4 as shown in FIG. 12B.

The Japanese-to-Chinese machine translation apparatus according to a third embodiment uses a dependent-word dictionary and a dependent-word connection table. The dependent-word dictionary contains hiragana characters or hiragana strings which can be connected to other Japanese word as dependent-words. This Japanese-to-Chinese machine translation apparatus also determines whether the hiragana string contains a dependent-word which can be connected to the trailing Japanese word. When all the dependent-words of the hiragana string can be connected to each other, the hiragana string is determined to be not a proper noun and is not output.

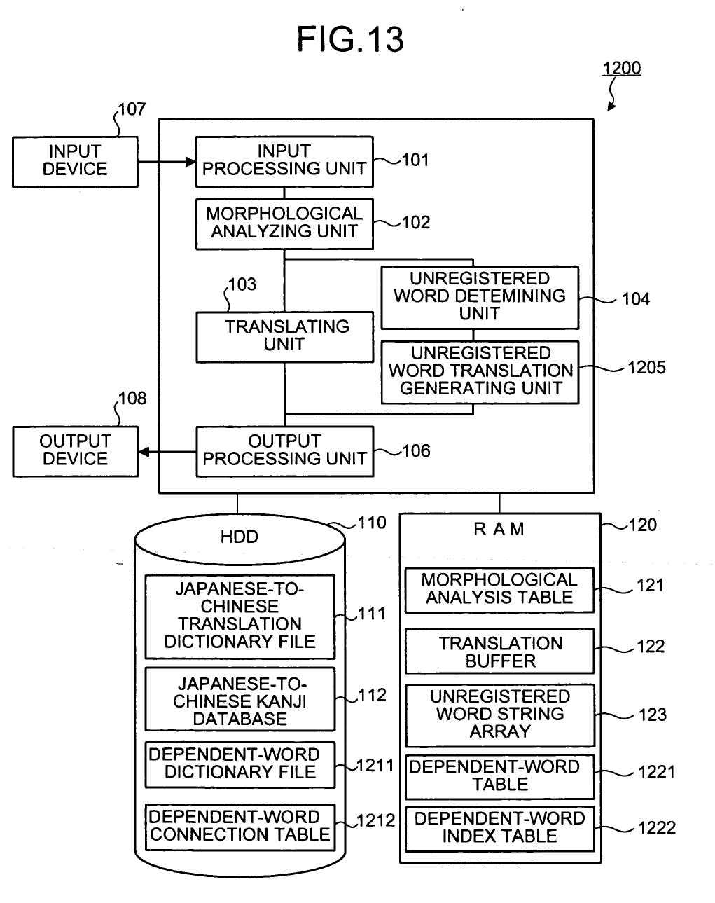

FIG. 13 is a functional block diagram of the Japanese-to-Chinese machine translation apparatus according to the third embodiment of the present invention. The Japanese-to-Chinese machine translation apparatus 2100 according to the third embodiment includes the input processing unit 101, the morphological analyzing unit 102, the translating unit 103, the unregistered word determining unit 104, an unregistered-word translation generating unit 1205, the output processing unit 106, the input device 107, the output device 108, the HDD 110, and the RAM 120.

The input processing unit 101, the morphological analyzing unit 102, the translating unit 103, the unregistered word determining unit 104, the unregistered-word translation generating unit 1205, the output processing unit 106, the input device 107, and the output device 108 are the same as those of the Japanese-to-Chinese machine translation apparatus 100 according to the first embodiment, and therefore, the explanation of these elements will be omitted.

The unregistered-word translation generating unit 1205 generates a translation of the unregistered word, when the unregistered word determining unit 104 determines that the Japanese word registered in the morphological analysis table 121 is a unregistered word. According to this embodiment, the unregistered-word translation generating unit 1205 divides a Japanese word as being the unregistered word into characters or strings for each character type (kanji, hiragana, katakana, and alphanumeric character, and the like). Besides, the string consisting of one or more dependent-words is extracted from the hiragana string, and the hiragana string is determined to be a translation when one of the dependent-words of the extracted hiragana string cannot be connected to the next dependent-word. The unregistered-word translation generating unit 1205 also determines that a Chinese kanji corresponding to a Japanese kanji is a translation to be output with reference to the Japanese-to-Chinese kanji database 111, as is the case with the unregistered-word translation generating unit 105 in the first embodiment. The translations of other characters, such as katakana and alphanumeric character are expressed in their original transcription.

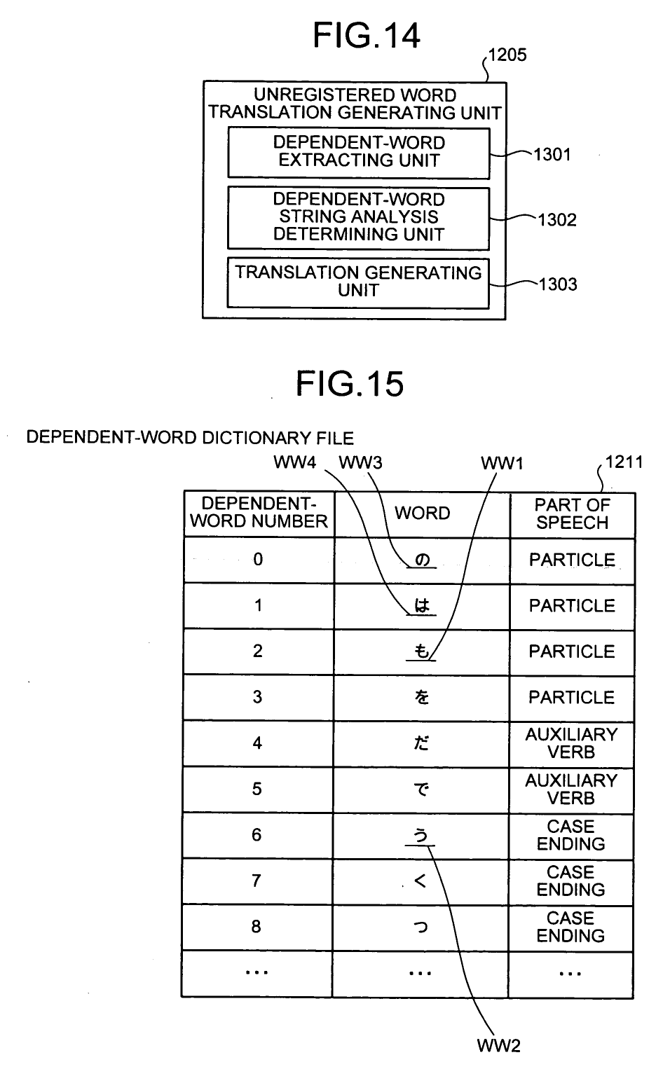

FIG. 14 is a functional block diagram of the unregistered-word translation generating unit 1205. The unregistered-word translation generating unit 1205 includes a dependent-word extractor 1301, a dependent-word string analysis determining unit 1302, and a translation generating unit 1303 as shown in FIG. 14.

The dependent-word extractor 1301 extracts a dependent-word string from a hiragana string of an unregistered word with reference to a dependent-word dictionary file 1211 as described later. The dependent-word string analysis determining unit 1302 determines whether each dependent-word of the extracted dependent-word string can be connected to the following dependent-word, that is, whether the dependent-word string can be analyzed, with reference to a dependent-word connection table 1212. The dependent-word string in this embodiment is referred as the hiragana string consisting of dependent-words which can be connected to each other.

The translating unit 1303 generates no translation of a hiragana string whose every dependent-word can be connected to the next dependent-word and which is determined that it can be analyzed as a dependent-word string by the dependent-word string analysis determining unit 1302. The translating unit 1303 also specified a hiragana string whose one dependent-word cannot be connected to the next dependent-word and which cannot be analyzed as a dependent-word string, to the original transcription as the translation.

Returning to FIG. 13, the Japanese-to-Chinese kanji database 111, the Japanese-to-Chinese translation file 112, the dependent-word dictionary file 1211, and the dependent-word connection table 1212 are stored in the HDD 110. The Japanese-to-Chinese kanji database 111 and the Japanese-to-Chinese translation file 112 are the same as these in the first embodiment, and therefore, the explanation of these elements will be omitted.

The dependent-word dictionary file 1211 is a dictionary file containing hiragana characters or hiragana strings which consist of dependent-words, and their part of speech.

FIG. 15 shows a data structure of a dependent-word dictionary file 1211. In the dependent-word dictionary file 1211, the dependent-word number to identify each dependent-word, the dependent-word (word), and the part of speech are associated with each other, as shown in FIG. 15. The part of speech of the dependent-word is mainly the particle, the auxiliary verb, and the case ending, as shown in FIG. 15.

The dependent-word connection table 1212 is data indicating connectable dependent-words.

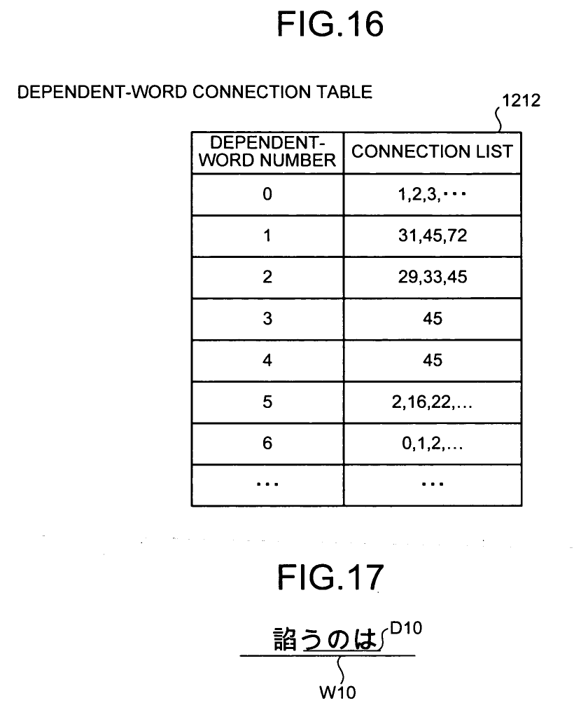

FIG. 16 shows a data structure of the dependent-word connection table 1212. In the dependent-word connection table 1212, each dependent-word number is associated with a connection list, as shown in FIG. 16. The connection list contains the dependent-word numbers each of which indicates the next dependent-word which can be connected to one dependent-word.

In FIG. 16, the dependent-word of the dependent-word number “2”, which indicates the word WW1 in FIG. 15, can be followed by the dependent-word of the dependent-word number “29”, “33”, or “45”.

If the unregistered word is, for example, a word W10 as shown in FIG. 17, a hiragana string D10 can be analyzed as a dependent-word string. Referring to the dependent-word dictionary file 1211 of FIG. 15, the hiragana string D10 can be divided into a dependent-word WW2 (dependent-word number “6”), a dependent-word WW3 (dependent-word number “0”), and a dependent-word WW4 (dependent-word number “1”). And referring to the dependent-word connection table 1212, the dependent-word WW2 of the dependent-word number “6” can be followed by the dependent-word WW3 of the dependent-word number “0”, and the dependent-word WW3 of the dependent-word number “0” can be followed by the dependent-word WW4 of the dependent-word number “1”. Accordingly, the dependent-words WW2, WW3, and WW4 of the hiragana string D10 can be sequentially connected to each other, and the hiragana string D10 can be analyzed as a dependent-word. Therefore, no translation of the hiragana string D10 is generated.

Returning to FIG. 13, the morphological analyzing unit 102 generates the morphological analysis table 121 in the RAM 120. The unregistered-word translation generating unit 1205 generates the translation buffer 122 and the unregistered word string array 123 in the RAM 120. Besides, the dependent-word extractor 1301 generates the dependent-word table 1221 and the dependent-word index table 1222 in the RAM 120. The morphological analysis table 121, the translation buffer 122, the unregistered word string array 123, the dependent-word table, and the dependent-word index table 1222 may be generated in the HDD 110 instead of the RAM 120.

The morphological analysis table 121, the translation buffer 122, and the unregistered word string array 123 are the same as those in the first embodiment, and therefore, the explanation of these elements will be omitted.

The dependent-word table 1221 contains data of the dependent-word included in the hiragana string of the unregistered word, and the dependent-word index table 1222 contains index data of the dependent-word included in the hiragana string of the unregistered word. The dependent-word table 1221 and the dependent-word index table 1222 will be described in detail later.

A whole process of Japanese-to-Chinese machine translation by the Japanese-to-Chinese machine translation apparatus 1200 according to this embodiment will now be explained below. The whole process of Japanese-to-Chinese machine translation by the Japanese-to-Chinese machine translation apparatus 1200 according to the third embodiment is the same as that of the first embodiment.

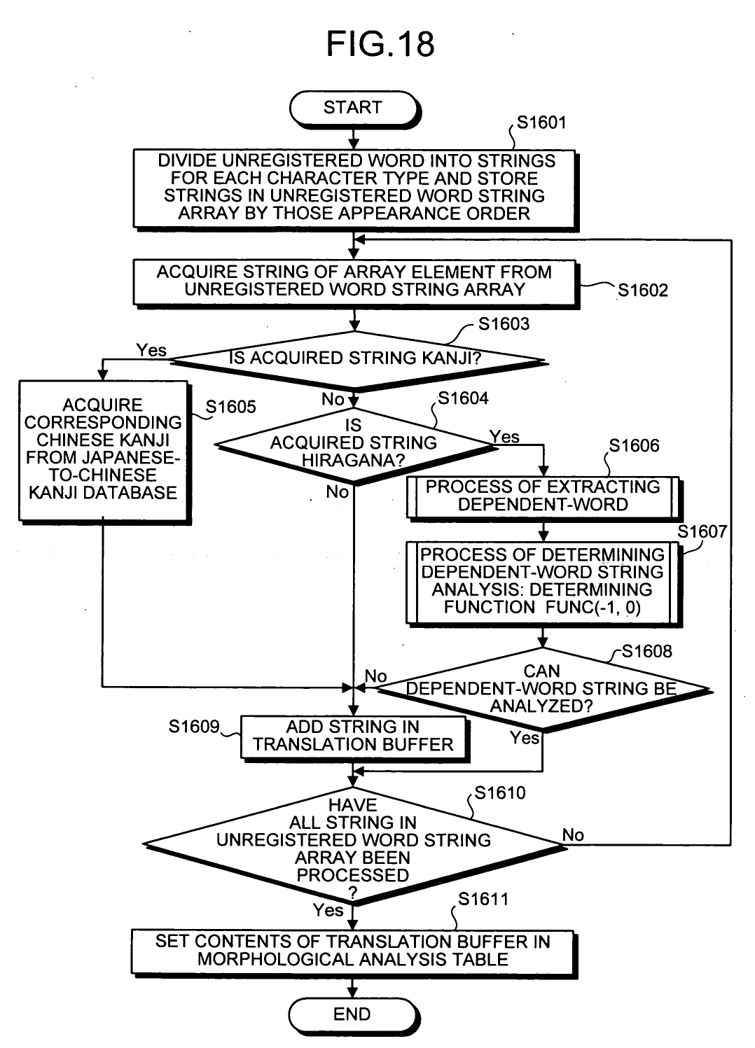

FIG. 18 is a flowchart of a process of generating a translation of an unregistered word by the unregistered-word translation generating unit 1205 of the Japanese-to-Chinese machine translation apparatus 1200 according to the third embodiment.

The process from steps S1601 to S1604, in which an unregistered word is divided into strings for each character type, the strings are stored in the unregistered word string array 123, and whether the stored string is hiragana is determined, is the same as the process from steps S601 to S604 in the first embodiment.

When the string is not hiragana (step S1604: No), the acquired non-hiragana string is added to the translation buffer 122 (step S1609).

When the acquired string is hiragana (step S1604: Yes), the dependent-word extractor 1301 performs a process of extracting a dependent-word (step S1606). Then, the dependent-word string analysis determining unit 1302 performs a process of determining dependent-word string analysis in which whether the dependent-words of the extracted string can be connected to each other is determined (step S1607). This process is concretely performs by issuing a determining function FUNC (−1, 0), and a return value of the determining function FUNC (−1, 0) represents whether the extracted string can be analyzed as a dependent-word string. Specifically, a return value of “1” indicates that the string can be analyzed as a dependent-word string, and a return value of “0” indicates that the string cannot be analyzed as a dependent-word string. The process of extracting the dependent-word and the process of determining the dependent-word string analysis will be described in detail later.

In the process of determining the dependent-word string analysis of step S1607, whether the hiragana string can be analyzed as a dependent-word string, that is, whether the return value of the determining function FUNC (−1, 0) is “1”, is determined. If the hiragana string can be analyzed (step S1608: Yes), no translation of the hiragana string is generated since the hiragana string of the unregistered word is a dependent-word string.

If the hiragana string is determined that it cannot be analyzed a dependent-word (step S1608: No), the hiragana string is added to the translation buffer 122 (step S1609).

After adding the string to the translation buffer 122, the process from steps S1602 to S1609 is repeatedly performed on the strings stored in all the array elements of the unregistered word string array 123 (step S1610), and then the contents of the translation buffer 122 is set to the morphological analysis table 121 (step S1611). The morphological analysis table 121 is supplied to the output processing unit 106 as the translation of the Japanese sentence, and thus the hiragana string which can be analyzed as a dependent-word string is determined that it is, for example, a declensional kana ending or a particle, and is output as no translation. However, if the hiragana string of the unregistered string cannot be analyzed as a dependent-word, then the hiragana string is determined to be, for example, a proper noun and is output as a translation.

The process of extracting the dependent-word by the dependent-word extractor 1301 in step S1606 will now be explained below.

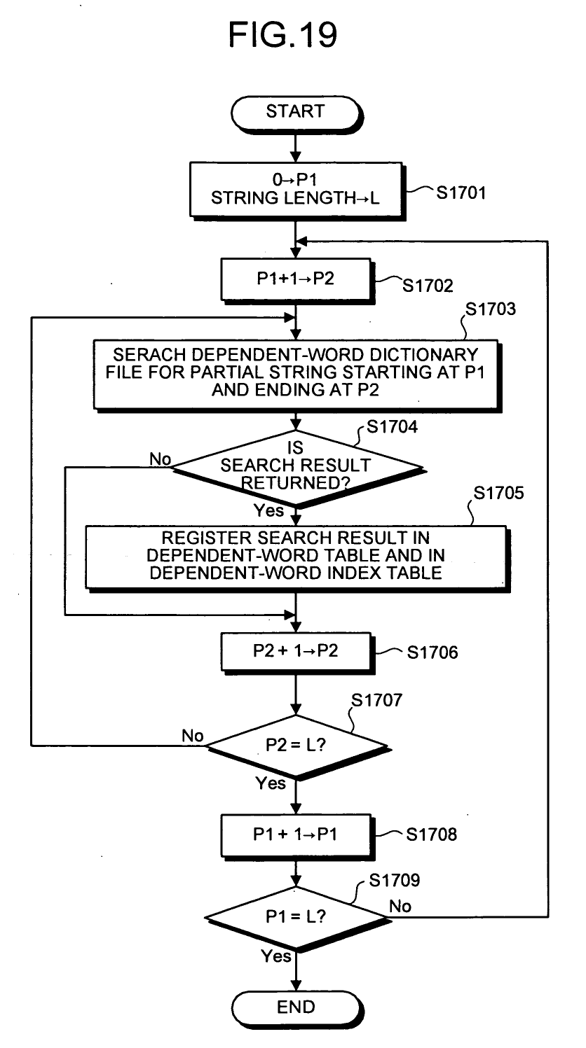

FIG. 19 is a flowchart of the process of extracting the dependent-word by dependent-word extractor 1301.

To begin with, the dependent-word extractor 1301 sets “0” to a pointer P1, and substitutes the string length of the hiragana string of the unregistered word for string length L (step S1701). P1 is a pointer referring to the starting point of a partial string to be taken from the hiragana string, and P1 of “0” indicates that the partial string is taken from the head of the string.

Then, a pointer P2, referring to the ending point of the partial string (i.e., the starting point of the following character), is initially set to P1+1 (step S1702). At this time, when there is no following character, the value of the pointer P2 is changed on the assumption that there is the following character.

Then, whether the partial string starting at the pointer P1 and ending at the pointer P2 is registered as a dependent-word is determined by searching the dependent-word dictionary file 1211 (step S1703). And, whether a search result is returned, in other words, whether the partial string is registered as a dependent-word, is determined (step S1704). When the search result is returned (step S1704: Yes), the dependent-word (the partial string) as being the search result is registered in the dependent-word table 1221 and the dependent-word index table 1222 (step S1705).

When the search result is not returned, in other words, if the partial string is not registered as a dependent-word (step S1704: No), the partial string is not registered in the dependent-word table 1221 and the dependent-word index table 1222.

Next, the pointer P2 is incremented by one character (step S1706), the process from steps S1703 to S1706 is repeated until the pointer P2, which indicates the ending point of the partial string, becomes the value of the string length L of the hiragana string, in other words, until the pointer P2 reaches the end of the hiragana string (step S1707). When the pointer P2 reaches the string length L in step S1707, then the pointer P1 is incremented by one character, and the process from steps S1702 to S1708 is repeated until the pointer P1, which indicates the starting point of the partial string, becomes the value of the string length L of the hiragana string, in other words, until the pointer P1 reaches the end of the hiragana string (step S1709). When the pointer P1 reaches the string length L in step S1709, the process ends. As a result, all the dependent-words of the hiragana string are extracted and registered in the dependent-word table 1221 and the dependent-word index table 1222.

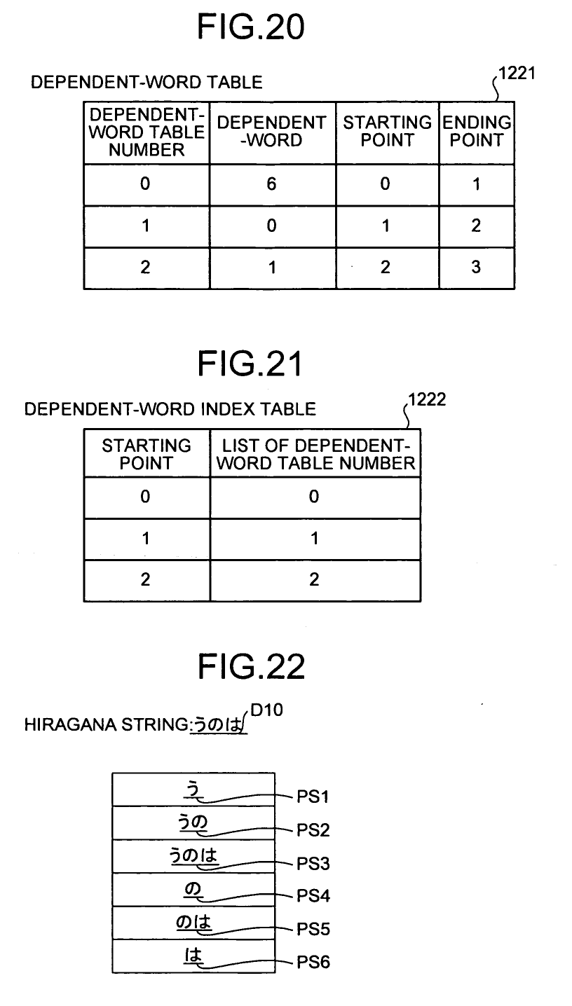

FIG. 20 shows a data structure of the dependent-word table 1221, in particular, an example of the dependent-word searched when the unregistered word is the word W10 of FIG. 17 on the assumption of the dependent-word dictionary file 1211 of FIG. 15. FIG. 21 shows a data structure of the dependent-word index table 1222, in particular, the index of the dependent-word table 1221 shown in FIG. 20.

Specifically, referring to FIG. 22, since the dependent-words registered in the dependent-word dictionary file 1211 out of partial strings PS1 to PS6 of the hiragana string D10 of the unregistered word are the partial strings PS1, PS4, and PS6, each of the partial strings (i.e., dependent-words) PS1, PS4, and PS6 is registered together with the dependent-word number, the starting point, and the ending number in the dependent-word table 1221, and is assigned with the dependent-word table number as being unique. The dependent-word index table 1222 is generated by sorting the dependent-words registered in the dependent-word table 1221 by a primary key of the starting point. Referring to FIG. 19, one dependent-word table number is registered in a field of “list of dependent-word table numbers” for each starting point. However, one starting point may be associated with a plurality of dependent-word table numbers or no dependent-word table number.

The process of the determining function FUNC for determining the dependent-word string analysis in step S1607 will now be explained.

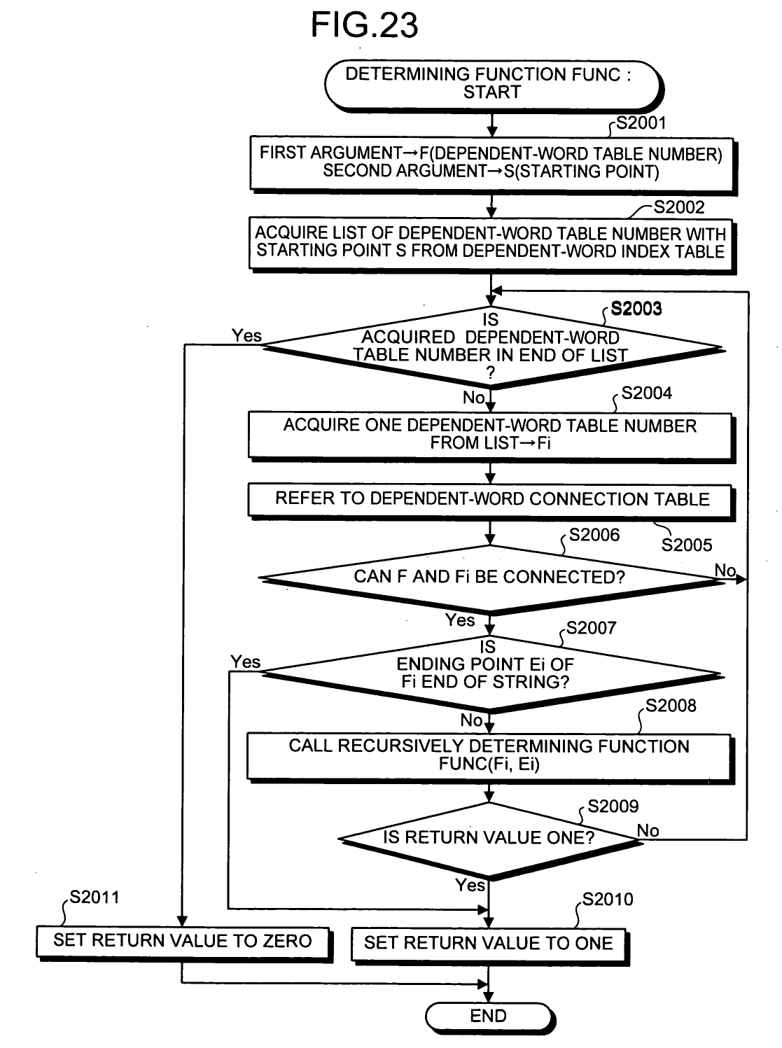

FIG. 23 is a flowchart of the process of the determining function FUNC.

The determining function FUNC takes two arguments. The first argument is a dependent-word table number, and the second argument is a starting point. The determining function FUNC determines whether the dependent-word identified by the first argument indicating the dependent-word table number can be connected to (specifically, followed by) the dependent-word of the string starting at the second argument indicating the starting point. If the two dependent-words can be connected to each other, a return value of “1” is returned. If the two dependent-words cannot be connected to each other, a return value of “0” is returned. To begin with, the dependent-word string analysis determining unit 1302 sets the first argument in a variable F, and sets the second argument in a variable S (step S2001). Then, the list of dependent-word table numbers for a starting point of S is acquired from the dependent-word index table 1222 (step S2002). And, whether it is the end of the list of dependent-word table numbers is determined (step S2003). When it is not the end of the list (step S2003: No), one dependent-word table number is acquired from the list, and is substituted for a variable Fi (step S2004).

Next, whether the dependent-word identified by the dependent-word number corresponding to the dependent-word table number Fi can be connected to the dependent-word identified by the dependent-word number corresponding to the dependent-word table number F is determined with reference to the dependent-word connection table 1212 (steps S2005, S2006). The dependent-word number corresponding to the dependent-word table number is acquired with reference to the dependent-word table 1221. Note that the dependent-word corresponding to the dependent-word table number Fi is connected to the dependent-word corresponding to the dependent-word table number F without conditions when F is −1, which indicates a special ID not used in the dependent-word table 1221.

If the dependent-word identified by the dependent-word number corresponding to the dependent-word table number Fi can be connected to the dependent-word identified by the dependent-word number corresponding to the dependent-word table number F (S2006: Yes), then whether the ending point Ei reaches the end of the hiragana string (step S2007). When the ending point Ei reaches the end of the hiragana string, then one is set to the return value (step S2007: Yes), and the process ends.

When the ending point Ei does not reach the end of the hiragana string (step S2007: No), Fi is set to the first argument and Ei is set to the second argument, and the determining function FUNC is recurrently called (step S2008). Then, whether the return value of the determining function FUNC is one (i.e., connectable) is determined (step S2009). When the return value is one (step S2007: Yes), the return value is set to one (step S2010), and the process ends.

When the return value of FUNC as being a recursive call is not one (step S2009: No), the following dependent-word table number is acquired from the list of dependent-word table numbers, which is acquired from the dependent-word index table 1222 in step S2002, and the process from steps S2003 to S2008 is repeatedly performed. When the acquired dependent-word table number is the end of the list of dependent-word table numbers, in other words, if the list is empty (step S2003: Yes), the return value is set to zero (step S2011), and the process ends.

When the dependent-word table 1221 and the dependent-word index table 1222 have the same contents as those shown in FIGS. 20 and 21, in other words, when F=−1 and S=0 in the flowchart of FIG. 23, only the dependent-word table number 0 has a staring point of “0”. Next, the dependent-word table number is acquired to let Fi=0. Since F=−1, Fi can be connected to F without conditions. Since the ending point Ei (=1) of Fi does not reach the end (=3) of the hiragana string, FUNC (0,1) is calculated recursively. Specifically, the flowchart shown in FIG. 23 is performed again as F=0 and S=1. Only the dependent-word table number 1 has a starting point of “1”, then let Fi=1. Referring to FIG. 20, the dependent-word number corresponding to F=0 is 6 and the dependent-word number corresponding to Fi=1 is 0, and thus the dependent-word of the dependent-word table number Fi can be connected to the dependent-word of the dependent-word table number F.

Since the ending point Ei (=2) of Fi does not yet reach the end (=3) of the hiragana string, FUNC (0,1) is calculated recursively. Specifically, the flowchart shown in FIG. 23 is performed again as F=1 and S=2. Only the dependent-word table number 2 has a starting point of “2”, then let Fi=2. Referring to the dependent-word table 1221 shown in FIG. 20, the dependent-word number corresponding to F=1 is 0 and the dependent-word number corresponding to Fi=2 is 1. Hence, referring to the dependent-word connection table 1212 shown in FIG. 16, the dependent-word of the dependent-word table number Fi can be connected to the dependent-word of the dependent-word table number F. When the ending point Ei (=3) of Fi reaches the end of the hiragana string, the return value 1 is returned and the current process is returned to step S2009 of the nest level of FUNC(−1, 0). Besides, the output in step S1607 of FIG. 18 becomes 1 since the return value 1 is returned. Hence, the hiragana string D10 can be analyzed as a dependent-word string. As describe above, therefore, no translation of the hiragana string D10 is generated.

The Japanese-to-Chinese machine translation apparatus 1200 according to the third embodiment uses the dependent-word dictionary containing hiragana characters or hiragana strings which can be connected to other Japanese word as dependent-words and the dependent-word connection table containing the dependent-words to be connected. This Japanese-to-Chinese machine translation apparatus 1200 also determines whether the hiragana string contains a dependent-word which can be connected to the trailing Japanese word. If all the dependent-words of the hiragana string can be connected to each other, the hiragana string is determined to be not a proper noun and is not output. Hence, whether the hiragana string is output as the original transcription or no translation is automatically determined based on the determination of whether the hiragana string of the unregistered string is an proper noun. As a result, it is possible to make a good impression at the quality of the machine translation.

The Japanese-to-Chinese machine translation apparatus according to the first to third embodiments includes a controller such as CPU, a memory such as ROM (Read Only Memory) or RAM, an external storage device such as a HDD or a CD drive, a display such as CRT or LCD, and an input device such as a keyboard or a mouse, and is designed as a hardware system including a general computer.

The Japanese-to-Chinese machine translation program executed by the Japanese-to-Chinese machine translation apparatus according to the first to third embodiments is recorded as a installable or executable file in a computer-readable storage medium, such as a CD-ROM, flexible disk (FD), CD-R, and DVD (Digital Versatile Disk).

The Japanese-to-Chinese machine translation program executed by the Japanese-to-Chinese machine translation apparatus according to the first to third embodiments may be configured to be stored in a computer connected with a network such as the Internet, to thereby download from the network. The Japanese-to-Chinese machine translation program may be configured to be provided or distributed via the network.

The Japanese-to-Chinese machine translation program may be configured to be provided by being built in a ROM or the like in advance.

The Japanese-to-Chinese machine translation program is implemented as modules including the components as described above, that is, the input processing unit 101, the morphological analyzing unit 102, the translating unit 103, the unregistered word determining unit 104, the unregistered-word translation generating unit 105 or 1205, and the output processing unit 106. As actual hardware, the CPU (processor) reads and executes the Japanese-to-Chinese machine translation program, so that the components are loaded in a primary storage, in other words, the input processing unit 101, the morphological analyzing unit 102, the translating unit 103, the unregistered word determining unit 104, the unregistered-word translation generating unit 105 or 1205, and the output processing unit 106 are implemented in the primary storage.

Although the Japanese-to-Chinese machine translation apparatus is taken as an example of a simplified apparatus, in which the accepted Japanese sentence is divided into words, and each word is assigned with a Chinese word, the Japanese-to-Chinese machine translation apparatus according to the present invention is also available to translate a Japanese sentence into a Chinese sentence.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A Japanese-to-Chinese machine translation apparatus, comprising:
a storage unit that stores a Japanese-to-Chinese translation dictionary file where Japanese words are associated with Chinese words;
an unregistered word determining unit that determines whether a Japanese word of the Japanese sentence is an unregistered word not registered in the Japanese-to-Chinese translation dictionary file; and
an unregistered-word translation generating unit that, when the unregistered word determining unit determines that the Japanese word is the unregistered word, divides the unregistered word into a hiragana string and a non-hiragana string, generates a translation of the non-hiragana string with reference to the Japanese-to-Chinese translation dictionary file, and does not generate a translation of the hiragana string.

2. The Japanese-to-Chinese machine translation apparatus according to claim 1, wherein the storage unit stores Japanese-to-Chinese kanji database where a Japanese kanji character is associated with a transcription of a Chinese kanji character corresponding to the Japanese kanji character,
wherein the unregistered-word translation generating unit adopts, as a translation of a Japanese kanji character in the non-hiragana string, a Chinese kanji character corresponding to the Japanese kanji character with reference to the Japanese-to-Chinese kanji database.

3. The Japanese-to-Chinese machine translation apparatus according to claim 2, wherein the unregistered-word translation generating unit adopts, as a translation of a character other than the Japanese kanji character in the non-hiragana string, a transcription of the character other than the Japanese kanji character.

4. A Japanese-to-Chinese machine translation apparatus, comprising:
a storage unit that stores a Japanese-to-Chinese translation dictionary file where Japanese words are associated with Chinese words;
an unregistered word determining unit that determines whether a Japanese word of the Japanese sentence is an unregistered word not registered in the Japanese-to-Chinese translation dictionary file; and
an unregistered-word translation generating unit that, when the unregistered word determining unit determines that the Japanese word is the unregistered word, divides the unregistered word into a hiragana string and a non-hiragana string, and does not generate a translation of the hiragana string whose number of characters or syllables is not more than a predetermined value.

5. The Japanese-to-Chinese machine translation apparatus according to claim 4, wherein the unregistered-word translation generating unit that, when the unregistered word determining unit determines that the Japanese word is the unregistered word, divides the unregistered word into a hiragana string, and adopts a transcription of the hiragana string as a translation of the hiragana string whose number of characters or syllables is not less than the predetermined value.

6. The Japanese-to-Chinese machine translation apparatus according to claim 4, wherein the storage unit stores Japanese-to-Chinese kanji database where a Japanese kanji character is associated with a transcription of a Chinese kanji character corresponding to the Japanese kanji character,
wherein the unregistered-word translation generating unit adopts as a translation of a Japanese kanji character in the non-hiragana string a Chinese kanji character corresponding to the Japanese kanji character with reference to the Japanese-to-Chinese kanji database.

7. The Japanese-to-Chinese machine translation apparatus according to claim 6, wherein the unregistered-word translation generating unit adopts, as a translation of a character other than the Japanese kanji character in the non-hiragana string, a transcription of the character other than the Japanese kanji character.

8. A Japanese-to-Chinese machine translation apparatus, comprising:
a storage unit that stores a Japanese-to-Chinese translation dictionary file where Japanese words are associated with Chinese words as being translations of the Japanese words;
an unregistered word determining unit that determines whether a Japanese word contained in a Japanese sentence is an unregistered word not registered in the Japanese-to-Chinese translation dictionary file; and
an unregistered-word translation generating unit that, when the unregistered word determining unit determines that the Japanese word is the unregistered word, divides the unregistered word into a hiragana string and a non-hiragana string, and does not generate a translation of the hiragana string which is a dependent-word connectable to other Japanese word.

9. The Japanese-to-Chinese machine translation apparatus according to claim 8, wherein the storage unit stores dependent-word dictionary database including a dependent-word connectable to other Japanese word in the hiragana string, and dependent-word connection data where the dependent-word is associated with other dependent-word connectable to the dependent-word,
wherein the unregistered-word translation generating unit includes
a dependent-word extracting unit that, when the unregistered word determining unit determines that the Japanese word is the unregistered word, divides the unregistered word into a hiragana string and a non-hiragana string, and extracts from the hiragana string a dependent-word registered in the dependent-word dictionary database;
a dependent-word string analysis determining unit that determines whether the extracted dependent-word can be connected to a following dependent-word; and
a translation generating unit that does not generate a translation of the hiragana string that the extracted dependent-word can be connected to the following dependent-word by the dependent-word string analysis determining unit.

10. The Japanese-to-Chinese machine translation apparatus according to claim 9, wherein the translation generating unit adopts as a translation of the hiragana string that the extracted dependent-word cannot be connected to the following dependent-word by the dependent-word string analysis determining unit a transcription of the hiragana string.

11. The Japanese-to-Chinese machine translation apparatus according to claim 8, wherein the storage unit stores Japanese-to-Chinese kanji database where a Japanese kanji character is associated with a transcription of a Chinese kanji character corresponding to the Japanese kanji character,
wherein the unregistered-word translation generating unit adopts, as a translation of a Japanese kanji character in the non-hiragana string, a Chinese kanji character corresponding to the Japanese kanji character with reference to the Japanese-to-Chinese kanji database.

12. The Japanese-to-Chinese machine translation apparatus according to claim 11, wherein the unregistered-word translation generating unit adopts, as a translation of a character other than the Japanese kanji character in the non-hiragana string, a transcription of the character other than the Japanese kanji character.

13. A Japanese-to-Chinese machine translation method, comprising:
determining whether a Japanese word contained in a Japanese sentence is an unregistered word not registered in a Japanese-to-Chinese translation dictionary file where Japanese words are associated with Chinese words; and
when the Japanese word is the unregistered word, dividing the unregistered word into a hiragana string and a non-hiragana string, and generating a translation of the non-hiragana string with reference to the Japanese-to-Chinese translation dictionary file, without generating a translation of the hiragana string.

14. A Japanese-to-Chinese machine translation method, comprising:
determining whether a Japanese word contained in a Japanese sentence is an unregistered word not registered in a Japanese-to-Chinese translation dictionary file where Japanese words are associated with Chinese words; and
when the Japanese word is the unregistered word, dividing the unregistered word into a hiragana string and a non-hiragana string, and generating no translation of the hiragana string whose number of characters or syllables is not more than a predetermined value.

15. A Japanese-to-Chinese machine translation method, comprising:
determining whether a Japanese word contained in a Japanese sentence is an unregistered word not registered in a Japanese-to-Chinese translation dictionary file where Japanese words are associated with Chinese words; and
when the Japanese word is the unregistered word, dividing the unregistered word into a hiragana string and a non-hiragana string, and generating no translation of the hiragana string which is a dependent-word connectable to other Japanese word.

16. A computer program product having a computer readable medium including programmed instructions, wherein the instructions, when executed by a computer, cause the computer to perform:
determining whether a Japanese word contained in a Japanese sentence is an unregistered word not registered in a Japanese-to-Chinese translation dictionary file where Japanese words are associated with Chinese words; and
when the Japanese word is the unregistered word, dividing the unregistered word into a hiragana string and a non-hiragana string, and generating a translation of the non-hiragana string with reference to the Japanese-to-Chinese translation dictionary file, without generating a translation of the hiragana string.

17. A computer program product having a computer readable medium including programmed instructions, wherein the instructions, when executed by a computer, cause the computer to perform:
determining whether a Japanese word contained in a Japanese sentence is an unregistered word not registered in a Japanese-to-Chinese translation dictionary file where Japanese words are associated with Chinese words; and
when the Japanese word is the unregistered word, dividing the unregistered word into a hiragana string and a non-hiragana string, and generating no translation of the hiragana string whose number of characters or syllables is not more than a predetermined value.

18. A computer program product having a computer readable medium including programmed instructions, wherein the instructions, when executed by a computer, cause the computer to perform:
determining whether a Japanese word contained in a Japanese sentence as a morpheme is an unregistered word not registered in a Japanese-to-Chinese translation dictionary file where Japanese words are associated with Chinese words; and
when the Japanese word is the unregistered word, dividing the unregistered word into a hiragana string and a non-hiragana string, and generating no translation of the hiragana string which is a dependent-word connectable to other Japanese word.
